(19) United States
(12) Patent Application Publication
(10) Pub. No.: US 2013/0254808 A1
(43) Pub. Date: Sep. 26, 2013

(54) ELECTRONIC APPARATUS AND DISPLAY CONTROL METHOD

(71) Applicant: KABUSHIKI KAISHA TOSHIBA, Tokyo (JP)

(72) Inventors: Tetsuya Fujii, Fussa-shi (JP); Masaya Kato, Ome-shi (JP); Atsushi Onoda, Ageo-shi (JP); Kazuyuki Okano, Kunitachi-shi (JP); Shunsuke Oike, Kobubunji-shi (JP); Yuji Takao, Hino-shi (JP); Tomomi Nishiguchi, Ome-shi (JP); Yoshinori Nishimoto, Kunitachi-shi (JP)

(73) Assignee: KABUSHIKI KAISHA TOSHIBA, Tokyo (JP)

(21) Appl. No.: 13/710,144

(22) Filed: Dec. 10, 2012

(30) Foreign Application Priority Data
Mar. 26, 2012 (JP) 2012-070096

(51) Int. Cl. H04N 21/482

(52) U.S. Cl. CPC H04N 21/482
USPC 725/43

(57) ABSTRACT

According to at least one embodiment, an electronic apparatus includes a TV module and a Web browser module. The TV module extracts EPG information from a broadcast signal, extracts program information of a broadcast program from the EPG information, transmits the program information to the Web browser module, receives external video data from the Web browser module, and displays video by using the external video data. The Web browser module receives the program information from the TV module, extracts keywords from the program information, retrieves information relating to a keyword of the keywords after the keyword is transmitted to a server, and transmits the external video data for displaying the retrieved information to the TV module.

### CROSS-REFERENCE TO RELATED APPLICATIONS

This application is based upon and claims the benefit of priority from Japanese Patent Application No. 2012-070096, filed Mar. 26, 2012, the entire contents of which are incorporated herein by reference.

### FIELD

Embodiments described herein relate generally to an electronic apparatus which can receive a broadcast signal, and a display control method applied to the apparatus.

### BACKGROUND

In recent years, a television receiver with a function of displaying an electronic program guide (EPG) has been used. A user manipulates a displayed electronic program guide, for example, by using a remote controller supplied with a television receiver, thus being able to confirm programs which are broadcast and select a program that is to be viewed, and to execute programmed viewing or programmed recording of a program. By the electronic program guide, the user can confirm the titles of programs, the names of performers appearing in programs, and brief descriptions of programs.

When the user wishes to learn detailed information relating to a program or a performer, the user accesses a search site on the Internet by using, for example, a personal computer (PC) or a smartphone, and executes a Web search (Internet search) with the title of the program or the name of the performer being used as a keyword. However, in some cases, a user who is not familiar with the operation of the PC or smartphone takes a long time in the operation of inputting a keyword for a Web search, and it is difficult for such a user to obtain detailed information in a short time.

In recent years, there has also been provided a television receiver which is connected to a network and has a Web browser function of displaying a Web page. By a predetermined operation, the user switches a screen that is displayed on the television receiver, from a television screen to a Web browser screen, and can execute a Web search by using the Web browser screen.

In this television receiver, for example, a process for a Web browser function is also executed by a processor (chip) for a television function for viewing a program. However, it is possible that a high-level function, such as a Web browser application program, which is executed on the PC, cannot be provided by the hardware capability of this processor. In addition, this processor executes a process for the television function and a process for the Web browser function by switching them. Thus, there is a possibility that when a Web search has been requested by the user, it is difficult to quickly present a search result.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an electronic apparatus according to an embodiment.

FIG. 2 is an exemplary block diagram illustrating a system configuration of the electronic apparatus of the embodiment.

FIG. 3 is an exemplary block diagram illustrating the functional configuration of a television module provided in the electronic apparatus of the embodiment.

FIG. 4 is an exemplary block diagram illustrating the functional configuration of a Web browser module provided in the electronic apparatus of the embodiment.

FIG. 5 is an exemplary view for describing an example of switching between a television screen and a Web browser screen by the electronic apparatus of the embodiment.

FIG. 6 is an exemplary view illustrating a Web browser screen displayed by the electronic apparatus of the embodiment.

FIG. 7 is an exemplary view illustrating an example of the external appearance of a remote controller for operating the electronic apparatus of the embodiment.

FIG. 8 is an exemplary view illustrating an example of the procedure of a display control process executed by the electronic apparatus of the embodiment.

### DETAILED DESCRIPTION

Various embodiments will be described hereinafter with reference to the accompanying drawings.

In general, according to one embodiment, an electronic apparatus includes a television module and a Web browser module. The television module includes a tuner, a video processor, program information storage, a program information extractor, a first communicator, and a video input. The tuner is configured to receive a broadcast signal of a first channel. The video processor is configured to display first video on a screen by using video data of a first broadcast program, wherein the video data is carried by the broadcast signal. The program information storage is configured to store electronic program guide information extracted from the broadcast signal in storage. The program information extractor is configured to extract first program information of the first broadcast program from stored electronic program guide information while the first video is being displayed. The first communicator is configured to transmit the first program information to the Web browser module. The video input is configured to receive external video data transmitted from the Web browser module. The video processor is configured to display second video on the screen by using the external video data while the first video is being displayed. The Web browser module includes a second communicator, a keyword extractor, a retriever, and a video output. The second communicator is configured to receive the first program information from the television module. The keyword extractor is configured to extract one or more keywords from the first program information. The retriever is configured to retrieve information relating to a first keyword of the one or more keywords after the first keyword is transmitted to a first server. The video output is configured to transmit the external video data to the television module, the external video data being suitable for displaying a list of the one or more keywords and the information relating to the first keyword.

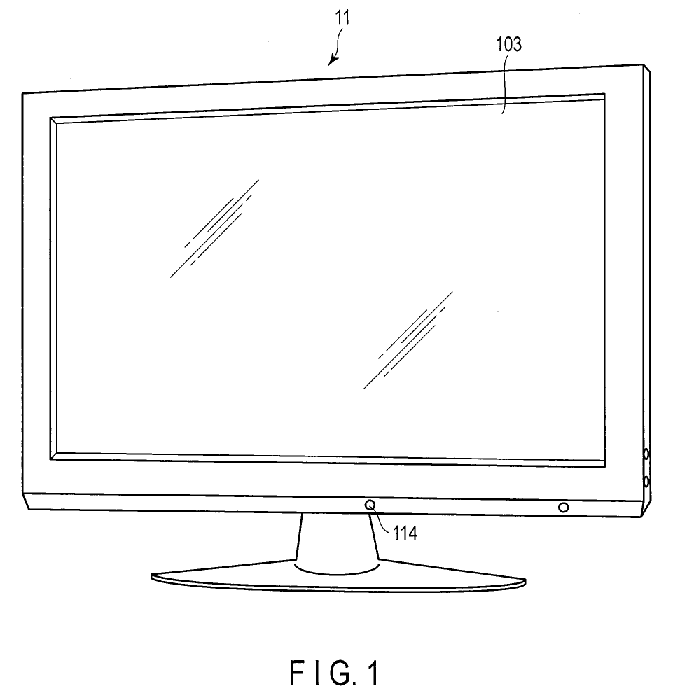

FIG. 1 is a perspective view illustrating the external appearance of an electronic apparatus according to an embodiment. This electronic apparatus is realized, for example, as a digital broadcast receiver 11. This electronic apparatus may also be realized as various types of consumer equipment, such as a personal video recorder or a personal computer. The digital broadcast receiver 11 has a thin box-shaped housing, and a liquid crystal display (LCD) 103 is built in the housing. In addition, a signal receiver (e.g. photoreceptor) 114, which receives a signal transmitted from a remote controller, is disposed at a lower part of the front surface of the housing.

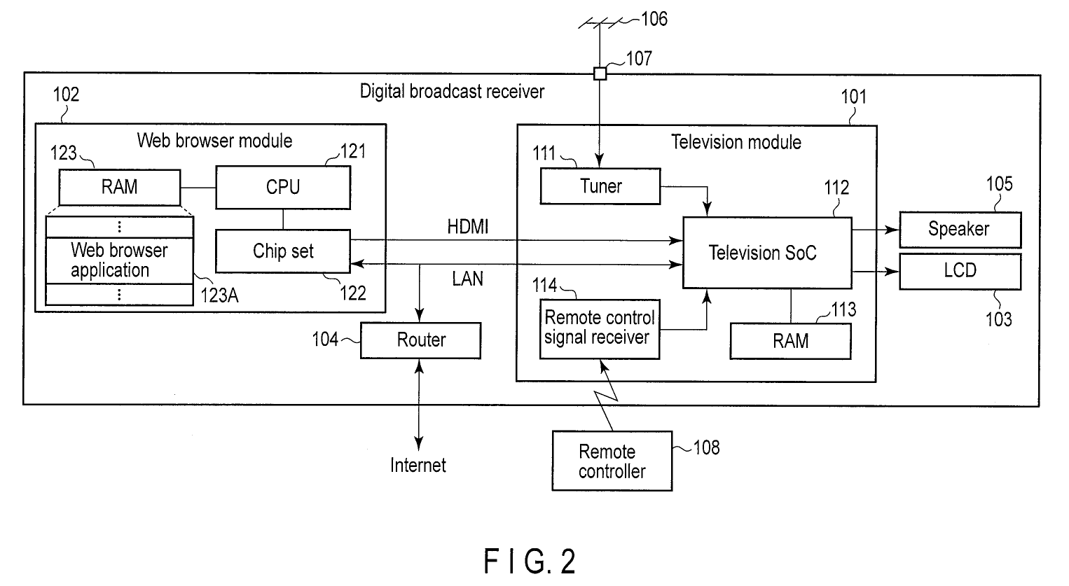

FIG. 2 illustrates an example of the system configuration of the digital broadcast receiver 11.

The digital broadcast receiver 11 includes, for example, a television module 101, a Web browser module 102, the liquid crystal display (LCD) 103, a router 104, a speaker 105, and a broadcast signal input terminal 107.

An antenna 106 for receiving terrestrial digital broadcast is connected to the broadcast signal input terminal 107. An antenna (not shown) for receiving BS/CS digital broadcast may be connected to the broadcast signal input terminal 107.

The television module 101 includes a television function of outputting video and audio of a television program which is being broadcast, by using a broadcast signal received via the broadcast signal input terminal 107. The television module 101 includes, for example, a tuner 111, a television-integrated processor (television system-on-a-chip (SoC)) 112, a RAM 113, and a remote control signal receiver 114.

In order to realize viewing of a television program, the television SoC 112 executes a predetermined process, such as demodulation or decoding, on a broadcast signal such as a terrestrial digital broadcast signal or a BS/CS digital broadcast signal, which has been received by the tuner 111. Thereby, the television SoC 112 displays first video on the LCD 103 by using video data of a broadcast program, and outputs audio to the speaker 105 by using audio data of the broadcast program. The video data and audio data are carried by the broadcast signal. The television SoC 112 also includes a function of storing electronic program guide (EPG) information, which is included in the broadcast signal, in the RAM 113.

The television SoC 112 further includes a function of receiving external video data and external audio data (i.e. digital video signal and audio signal) which have been output by the Web browser module 102, by using a high-definition multimedia interface (HDMI) connection with the Web browser module 102. The television SoC 112 displays either first video using video data of a broadcast program, or second video using external video data output from the Web browser module 102, on the LCD 103 by a function of switching an input video signal. In addition, the television SoC 112 includes a function of communicating with the Web browser module 102 (“inter-CPU communication”) by using a network connection such as a LAN (Ethernet™) with the Web browser module 102. By using this communication, the operation of the entirety of the digital broadcast receiver 11 can be controlled. By using this LAN connection, the television SoC 112 requests the Web browser module 102 to execute, for example, a Web search relating to a broadcast program.

The remote control signal receiver 114 receives a control signal (e.g. an infrared signal) transmitted from the remote controller 108. This control signal is associated with an operation by the user with use of the remote controller 108. The remote control signal receiver 114 outputs the received control signal to the television SoC 112. Based on the control signal output from the remote control signal receiver 114, the television SoC 112 controls, for example, switching of a channel, turning up/down of sound volume, switching of an input signal, and operations on various menu screens.

The Web browser module 102 has a hardware configuration (motherboard) which is similar to the hardware configuration of a computer such as a notebook-type personal computer (PC) or a tablet-type PC, in order to execute a Web browser application program 123A. There is known a digital broadcast receiver which also realizes a Web browser function, for example, by a television module for realizing a television function. With the hardware capability of this television module (television SoC), however, it is difficult to provide a sufficient function as a Web browser. In addition, there is a possibility that a response to a search request by the user delays. Taking this into account, in the present embodiment, the Web browser module 102 is provided separately from the television module 101. Thereby, a Web browser function with a higher capability can be provided.

The Web browser module 102 includes, for example, a CPU 121, a chip set 122, and a RAM 123.

The CPU 121 controls the operations of the respective components in the Web browser module 102. The CPU 121 executes various programs, such as the Web browser application program 123A loaded in the RAM 123. The Web browser application program 123A is software for executing a Web browser function. The Web browser application program 123A executes, for example, a search process for executing a Web search (hereinafter, also referred to as “Internet search”) relating to a broadcast program which is being viewed, and a display control process for displaying a Web page including a search result, etc. on the LCD 103. The Web browser application program 123A may be executed on the background, while a broadcast program is being viewed by the television function of the television module 101. Thereby, it is possible to enhance a response at a time when a Web search has been requested by the television module 101 (television SoC 112).

The chip set 122 includes a graphics function, and includes a function of transmitting (outputting) external video data and external audio data to the television module 101 by using the HDMI connection with the television module 101. The chip set 122 includes a function of communicating with the television module 101 by using a network connection such as a LAN (Ethernet) with the television module 101. In this network connection, the chip set 122 can further access the Internet via the router 104. The Web browser application program 123A, which is executed by the CPU 121, executes a Web search by accessing the Internet via the router 104.

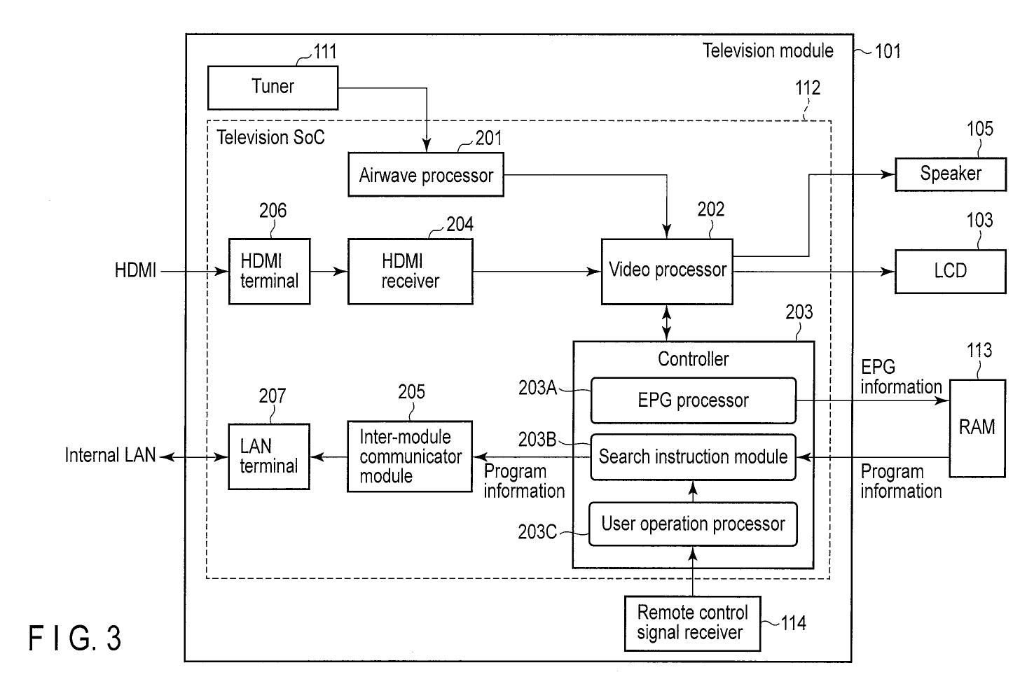

FIG. 3 illustrates the functional configuration of the television module 101. The television SoC 112 includes an airwave processor 201, a video processor 202, a controller 203, an HDMI receiver 204, an inter-module communication module 205, an HDMI terminal 206, and a LAN terminal 207.

The airwave processor 201 demodulates a broadcast signal selected (received) by the tuner 111, and extracts video data and audio data of a broadcast program, and service information (SI) including information for displaying an electronic program guide (EPG). The airwave processor 201 outputs the extracted video data and audio data, and service information to the video processor 202.

In addition, the HDMI receiver 204 receives external video data and external audio data via the HDMI terminal 206. The HDMI receiver 204 receives external video data and external audio data, for example, from the Web browser module 102 which is connected via the HDMI terminal 206. The HDMI receiver 204 outputs the received external video data and external audio data to the video processor 202.

The video processor 202 executes either a first process or a second process. The first process includes displaying on the LCD 103 video by using the video data which has been output by the airwave processor 201. The second process includes displaying on the LCD 103 video by using the external video data which has been output by the HDMI receiver 204. In the first process and second process, target video data is subjected to a predetermined digital signal process such as decoding. In the description below, first video, which is displayed by the first process, is also referred to as “television screen”, and second video, which is displayed by the second process, is also referred to as “Web browser screen”. For example, responding to a request by the controller 203, the video processor 202 selects either the first process or the second process, thereby displaying either the television screen or the Web browser screen on the LCD 103. Incidentally, in the first process, audio may also be output to the speaker 105 by using the audio data which has been output by the airwave processor 201. In addition, in the second process, audio may be output to the speaker 105 by using the external audio data which has been output by the HDMI receiver 204, or audio may be output to the speaker 105 by using the audio data which has been output by the airwave processor 201.

Furthermore, the video processor 202 outputs the service information (SI) which has been output by the airwave processor 201, to the controller 203.

The controller 203 controls the operations of the respective components in the television SoC 101. The controller 203 includes an EPG processor 203A, a search instruction module 203B and a user operation processor 203C.

The EPG processor 203A extracts information for displaying an EPG, from the service information (SI) which has been output by the video processor 202. The EPG processor 203A extracts, for example, an event information table (EIT) from the SI. In this EIT, EPG information, such as a start time, a program length, a program title, a performer name and a program genre, is described in association with each program (event). The EPG processor 203A accumulates the EPG information by storing the EPG information in the RAM 113 or the like.

In accordance with various control signals which are received by the remote control signal receiver 114, the user operation processor 203C executes processes associated with the control signals. As described above, the remote control signal receiver 114 receives a control signal which is output in accordance with an operation using the remote controller 108, and outputs the received control signal to the user operation processor 203C. Accordingly, in the user operation processor 203C, a process, which is associated with the operation using the remote controller 108, is executed.

For example, while a broadcast program is being viewed, in response to a control signal indicative of channel switching output from the remote control signal receiver 114, the user operation processor 203C requests the tuner 111 to select a broadcast signal corresponding to a channel after switching. In addition, while a Web browser screen is being displayed, in response to a control signal indicative of channel switching output from the remote control signal receiver 114, the user operation processor 2030 requests the tuner 111 to select a broadcast signal corresponding to a channel after switching, and also requests the video processor 202 to switch the screen of the LCD 103 from the Web browser screen to a television screen.

Besides, for example, while a broadcast program is being viewed (i.e. while a television screen is being displayed), in response to a control signal indicative of a Web search output from the remote control signal receiver 114, the user operation processor 203C notifies the search instruction module 203B that a Web search relating to the viewed program has been requested, and also requests the video processor 202 to switch the screen of the LCD 103 from the television screen to a Web browser screen (i.e. to execute switching from the first process to the second process). In response to a control signal indicative of a Web search output from the remote control signal receiver 114 while a Web browser screen is being displayed, the user operation processor 203C requests the video processor 202 to switch the screen of the LCD 103 from the Web browser screen to a television screen (i.e. to execute switching from the second process to the first process).

Furthermore, in response to the output of a control signal indicative of an operation on an object (e.g. a button, an input area, a link to a Web page, etc.) in a screen while a Web browser screen is being displayed, the user operation processor 203C notifies the search instruction module 203B of information indicative of the description of the operation. This operation on the object is, for example, an operation indicative of an upward/downward/leftward/rightward direction or an operation indicative of decision, like an operation on a menu screen.

Similarly, in response to a control signal output from the remote control signal receiver 114 to the user operation processor 203C, the user operation processor 203C requests the respective components in the television module 101 to execute processes for varying a sound volume, switching an input signal, operating an object (GUI) in a screen, etc.

In response to the notification of a Web search request from the user operation processor 203C, the search instruction module 203B requests the Web browser module 102 via the internal LAN connection to execute a Web search relating a program that is being viewed. In addition, the search instruction module 203B transmits operation information indicative of the description of the operation on the Web browser screen, which has been output from the user operation processor 203C, to the Web browser module 102 via the internal LAN connection.

In the communication via the internal LAN connection, the communication with the Web browser module 102, which is connected via the LAN terminal 207, is controlled by the inter-module communication module 205. The inter-module communication module 205 transmits to the Web browser module 102, for example, data including a Web search request that is output from the search instruction module 203B, program information, operation information indicative of the description of an operation on the Web browser screen, etc.

In addition, the inter-module communication module 205 receives from the Web browser module 102 the data including a request for transmission of program information. The inter-module communication module 205 outputs the received data to the search instruction module 203B.

In response to the request for transmission of program information output from the inter-module communication module 205, the search instruction module 203B extracts program information associated with a program, which is being viewed, from the EPG information stored in the RAM 113, and then transmits the extracted program information to the Web browser module 102 via the internal LAN connection (inter-module communication module 205 and LAN terminal 207).

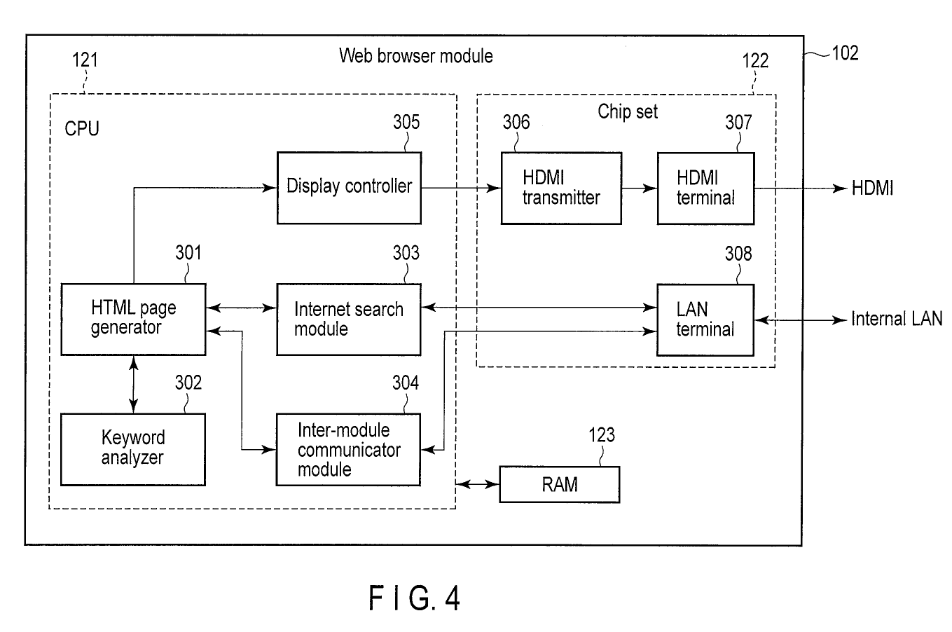

Next, referring to FIG. 4, a description is given of the functional structure of the Web browser module 102. The CPU 121 (the Web browser application program 123A executed by the CPU 121) includes an HTML page generator 301, a keyword analyzer 302, an internet search module 303, an inter-module communication module 304, and a display controller 305. The chip set 122 includes an HDMI transmitter 306, and HDMI terminal 307 and a LAN terminal 308.

The inter-module communication module 304 controls communication with the television module 101 which is connected (“internal LAN connection”) via the LAN terminal 308. The LAN terminal 207 of the television module 101 and the LAN terminal 308 of the Web browser module 102 are connected, for example, by a LAN cable. The inter-module communication module 304 receives from the television module 101, for example, the data including a Web search request, program information, and operation information indicative of an operation on a Web browser screen. The inter-module communication module 304 outputs the received data to the HTML page generator 301.

In the description below, to begin with, a description is given of the operation of the Web browser module 102 at a time when a Web search request, which was output from the inter-module communication module 304, has been received.

The HTML page generator 301 generates, for example, a HTML-format Web page, in response to the Web search request output from the inter-module communication module 304. To be more specific, in response to the Web search request, the HTML page generator 301 generates a Web page (hereinafter, also referred to as “in-search page”) which indicates that a search is being executed. The HTML page generator 301 outputs the generated in-search page to the display controller 305.

Subsequently, the HTML page generator 301 generates a Web page including a Web search result relating to a program which is being viewed. To be more specific, the HTML page generator 301 requests, via the internal LAN connection, the television module 101 (search instruction module 203B) to transmit program information associated with the program. The HTML page generator 301 acquires the program information which has been transmitted from the television module 101. Then, the HTML page generator 301 outputs the acquired program information to the keyword analyzer 302.

The keyword analyzer 302 analyzes the program information output from the HTML page generator 301, thereby extracting a keyword relating to the program. The keyword analyzer 302 executes, for example, a morphological analysis of a character string (text information) included in the program information, thereby extracting a program title or a performer name of the program. The keyword analyzer 302 extracts a word corresponding to a program title or a performer name from program information in languages such as English, as well as program information in Japanese. The keyword analyzer 302 outputs a list of keywords including extracted program titles and performer names to the HTML page generator 301.

The HTML page generator 301 outputs to the internet search module 303 a specific keyword (first keyword) of the keywords extracted by the keyword analyzer 302. This specific keyword is, for example, a program title.

The internet search module 303 executes a Web search by using the keyword output from the HTML page generator 301. The internet search module 303 accesses the Internet, for example, via the router 104 that is connected to LAN. The internet search module 303 transmits the specific keyword as a search word to a predetermined server (Web search site) on the Internet, thereby acquiring information relating to this keyword. Besides, the internet search module 303 may execute a Web search, for example, by using an API which is provided by a Web search site on the Internet and has the same function as a Web search based on a search word. Thereby, the internet search module 303 retrieves a search result including information of Web sites associated with the keyword (e.g. a URL of a Web site, or a part of the text in the Web site). The internet search module 303 outputs the retrieved search result to the HTML page generator 301.

The HTML page generator 301 generates a Web page (hereinafter, also referred to as “search result page”) by using the search result output from the internet search module 303. This Web page includes, for example, a list of keywords extracted by the keyword analyzer 302, and a search result output from the internet search module 303. The HTML page generator 301 outputs the generated search result page to the display controller 305.

The display controller 305 generates external video data for displaying the Web page (in-search page, search result page) output from the HTML page generator 301. The display controller 305 outputs the generated external video data to the HDMI transmitter 306.

The HDMI transmitter 306 transmits the external video data, which has been output from the display controller 305, to the television module 101 (HDMI receiver 204) which is connected (HDMI connection) via the HDMI terminal 307. The HDMI terminal 206 of the television module 101 and the HDMI terminal 307 of the Web browser module 102 are connected, for example, by an HDMI cable. In the television module 101, a Web browser screen is displayed on the LCD 103 by using this external video data.

Next, a description is given of the operation of the Web browser module 102 at a time when operation information indicative of an operation on the Web browser screen, which is displayed on the LCD 103, has been received. When the search instruction module 203B of the television module 101 has received, while the Web browser screen is being displayed, a control signal indicative of an operation, such as movement of a focus or selection (decision) of an object, from the remote control signal receiver 114, the search instruction module 203B transmits the corresponding operation information to the Web browser module 102 in association with each operation (control signal). The Web browser module 102 updates the Web page that is displayed, in accordance with the operation information which has been output from the inter-module communication module 304 and is indicative of the description of the operation on the Web browser screen.

Specifically, when the operation information is indicative of an operation of selecting a new keyword, the HTML page generator 301 causes the Internet search module 303 to execute a Web search using the new keyword, thereby generating a Web page including a search result relating to the new keyword. In addition, when the operation information is indicative of an operation of selecting a link embedded in the Web page, the HTML page generator 301 causes the Internet search module 303 to access the destination of this link, thereby receiving a Web page at the destination of the link. Specifically, the HTML page generator 301 generates (or receives) a Web page which is to be newly displayed, in accordance with the operation indicated in the operation information.

The display controller 305 generates external video data for displaying a Web browser screen including the Web page generated by the HTML page generator 301. In the meantime, the display controller 305 may update the external video data for displaying the Web browser screen in accordance with operation information each time the operation information has been received. For example, the display controller 305 updates the external video data so that a Web browser screen in response to an operation by the user (e.g. animation at a time when a button on the Web browser screen has been pressed, or movement of the focus in the keyword list) is displayed. By the above-described operation, the user can intuitively execute an operation on not only the television screen but also the Web browser screen.

In the meantime, the HDMI terminal 206 of the television module 101 and the HDMI terminal 307 of the Web browser module 102 are provided within the housing of the digital broadcast receiver 11 and are connected by a dedicated HDMI cable. Specifically, since the HDMI terminals 206 and 306 are invisible from the outside of the housing and are not opened for the use by the user, the user is unable to connect an external video device, etc., which output video data, to the HDMI terminals 206 and 306.

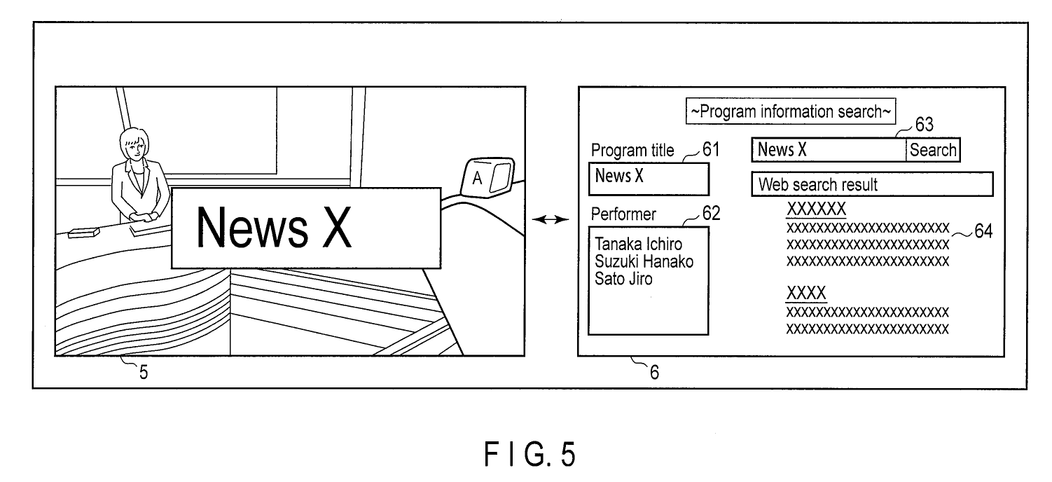

Next, referring to FIG. 5, a description is given of an example in which a television screen 5 and a Web browser screen 6 are switched and displayed on the LCD 103. For example, while the user is viewing a program “News X” on the television screen 5, the user performs an operation of requesting a Web search. In response to this operation, the Web browser screen 6 including a program information search page is displayed. The Web browser screen (program information search page) 6 includes, for example, a program title area 61, a performer name area 62, a keyword area 63, and a search result area 64. In the program title area 61, a program title included in EPG information, which corresponds to the program that is being viewed, is displayed. In the performer name area 62, a list of performer names included in the EPG information is displayed. In the keyword area 63, a keyword that is used for a Web search is input. In the search result area 64, a Web search result is displayed.

The user performs an operation of selecting one of keywords in the program title area 61 and performer name area 62, thus being able to check information relating to the program that is being viewed (i.e. “News X”). Thus, the user can easily acquire information relating to the program that is being viewed, without performing an operation of manually inputting a character string of a search target by using a keyboard, etc.

In addition, when the television screen 5 has been switched to the Web browser screen 6, a Web search can automatically be executed by using a keyword (specific keyword) belonging to a predetermined category. For example, it is assumed that a program title is set as this predetermined category. In this case, as in the Web browser screen 6 shown in FIG. 5, “News X” is set in the keyword area 63, and a Web search result for the “News X” is displayed in the search result area 64. That is, a Web search using the program title “News X” is automatically executed. Thereby, the search result relating to the program that is being viewed (e.g. a search result relating to the program title “News X”) can be displayed on the Web browser screen 6, by simply switching the television screen 5 to the Web browser screen 6.

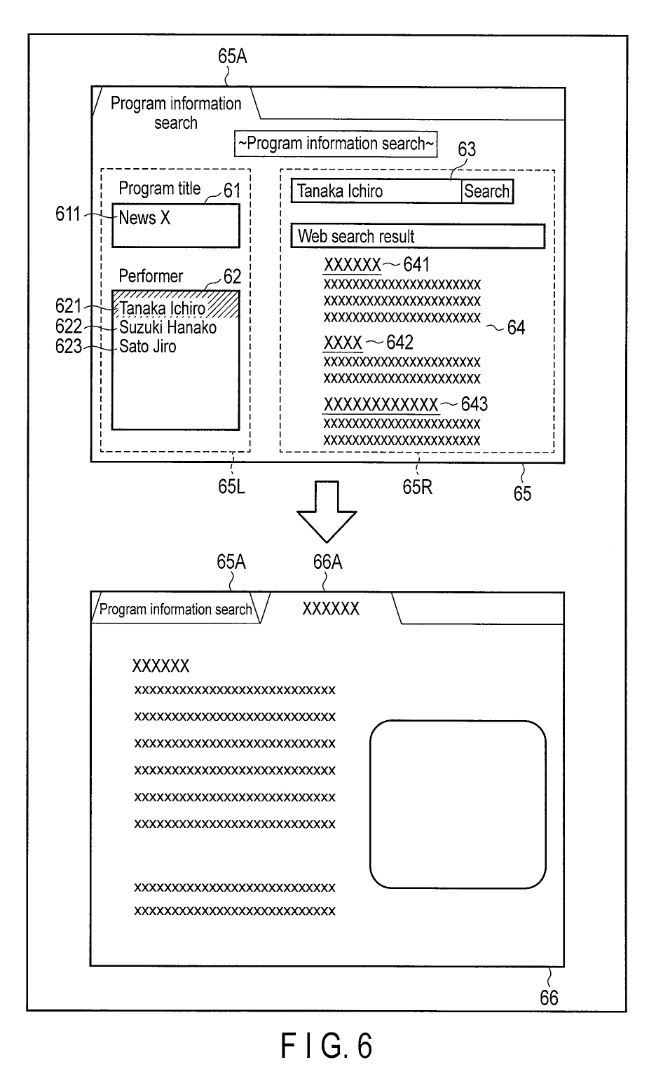

Next, referring to FIG. 6, a description is given of an operation on a program information search page 65 which is displayed on the Web browser screen 6. On the Web browser screen 6, a plurality of Web pages can be switched and displayed by using a plurality of tabs. It is now assumed that the program information search page 65 is displayed on a tab 65A.

The program information search page 65 includes, for example, two panes, namely a left pane 65L and a right pane 65R. In the left area 65L, a list of keywords (program title area 61 and performer name area 62), which are usable for a Web search, is displayed. An item 611 corresponding to a program title in the program title area 61 and items 621, 622 and 623 corresponding to performer names in the performer name area 62 are displayed such that these items are selectable. In response to one of the items 611, 621, 622 and 623 having been selected, a Web search using the selected item as a keyword is executed.

In addition, in the right pane 65R, the keyword area 63, which indicates a keyword selected from the list, and the search result area 64, which indicates a result of the Web search using the selected keyword, are displayed. In the search result area 64, for example, a search result, which is described in HTML, is displayed. The search result is described, for example, such that a title of a Web page and a part of the content of the Web page, are arranged in association with each of Web pages. The described title of the Web page includes a link function of a link to this Web page associated with the keyword used for the Web search. Titles (character strings) 641, 642 and 643 having the link function of links to Web pages are displayed to be selectable. In response to the title 641, 642, 643 having been selected, a Web page associated with (i.e. linked to) this title is displayed.

In the example shown in FIG. 6, in response to the user having selected the item “Tanaka Ichiro” 621 of the performer name, the performer name “Tanaka Ichiro” is displayed in the keyword area 63, and a Web search result of the Web search using “Tanaka Ichiro” as a keyword is displayed in the search result area 64. In addition, in response to the user having selected one title (character string) of the character strings 641, 642 and 643 corresponding to the titles in the search result area 64, a Web page 66, which is linked to the selected title, is displayed. This Web page 66 is displayed, for example, on a tab 66A. Accordingly, by selecting either of the tabs 65A and 66A, the user can cause the program information search page 65 or Web page 66, which corresponds to the selected tab, to be displayed.

The above-described operation is performed by using, for example, the remote controller 108.

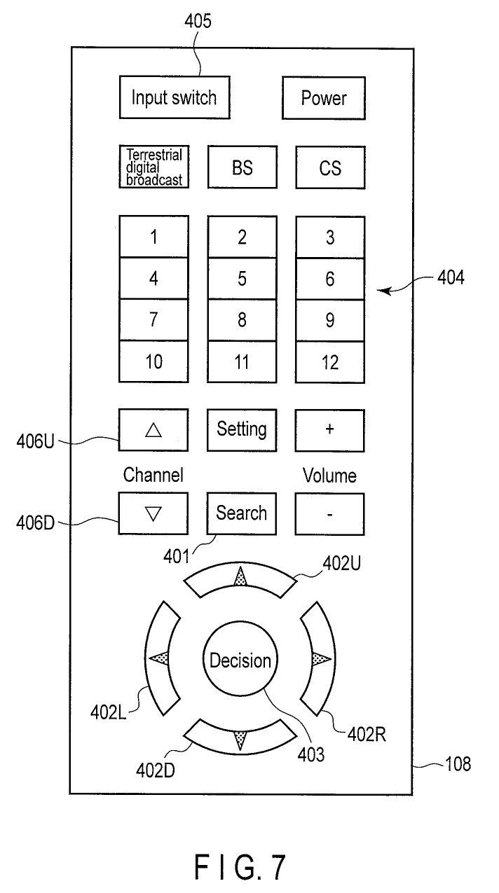

FIG. 7 shows an example of the remote controller 108 for inputting various control signals which are transmitted to the remote control signal receiver 114. In response to the pressing of an operation button, the remote controller 108 transmits a control signal corresponding to this operation button. The remote controller 108 includes, for example, a “search” button 401, an “up” button 402U, a “down” button 402D, a “left” button 402L, a “right” button 402R, a “decision” button 403, a plurality of “channel number” buttons 404, an “input switch” button 405, a “channel ascending-order switch” button 406U, and a “channel descending-order switch” button 406D.

The “search” button 401 is a button for starting an Internet search relating to a broadcast program that is being viewed. In response to the pressing of the “search” button 401 while the video of broadcast program data (i.e. television screen 5) is being displayed on the LCD 103, the video displayed on the LCD 103 is switched from the television screen 5 to the Web browser screen 6 for the Internet search relating to the broadcast program. In addition, in response to the pressing of the “search” button 401 while the Web browser screen 6 is being displayed on the LCD 103, the video displayed on the LCD 103 is switched from the Web browser screen 6 to the television screen 5. In short, each time the “search” button 401 is pressed, the television screen 5 and Web browser screen 6 are alternately displayed.

The “decision” button 403, “up” button 402U, “down” button 402D, “left” button 402L, and “right” button 402R are buttons for manipulating a graphical user interface (GUI) such as a menu displayed on the screen. In the program information search page 65 shown in FIG. 6, for example, in response to the pressing of the “right” button 402R at a time when the item “News X” 611 in the left pane 65L is in the selected state (focused state), the keyword area 63 in the right pane 65R is set in the selected state. In addition, for example, in response to the pressing of the “down” button 402D at a time when the item “News X” 611 is in the selected state, the item “Tanaka Ichiro” 621 is set in the selected state. Specifically, in response to the pressing of the “up” button 402U, “down” button 402D, “left” button 402L, and “right” button 402R, the select state (focus) for an object in the screen is moved. In response to the pressing of the “decision” button 403 at a time when any one of objects is set in the selected state, a process which is associated with this object is executed. For example, in response to the pressing of the “decision” button 403 at a time when the item “Tanaka Ichiro” 621 is set in the selected state, a Web search by a keyword “Tanaka Ichiro” is executed, and the search result is displayed in the search result area 64. Thus, the user can instruct execution of a Web search relating to the broadcast program, by selecting one keyword from the list of keywords in the program title area 61 and performer name area 62. In addition, when the title 641 in the search result area 64 is in the set in the selected state, the Web page 66 linked to the title 641 is displayed in response to the pressing of the “decision” button 403.

The “channel number” buttons 404 are buttons for switching to a channel corresponding to each of the buttons 404. The “channel ascending-order switch” button 406U is a button for switching channels in an ascending order. The “channel descending-order switch” button 406D is a button for switching channels in a descending order.

The “input switch” button 405 is a button for switching an input signal (input source) which is used for video display on the LCD 103. The input signal used for video display is, for example, video data which has been generated by the television module 101, video data which has been generated by the Web browser module 102, or video data which has been input via an external input terminal (not shown). Incidentally, the “input switch” button 405 may be a button for further switching an input signal used for audio output by the speaker 105. The input signal which is used for audio output is, for example, audio data which has been generated by the television module 101, audio data which has been generated by the Web browser module 102, or audio data which has been input via the external input terminal.

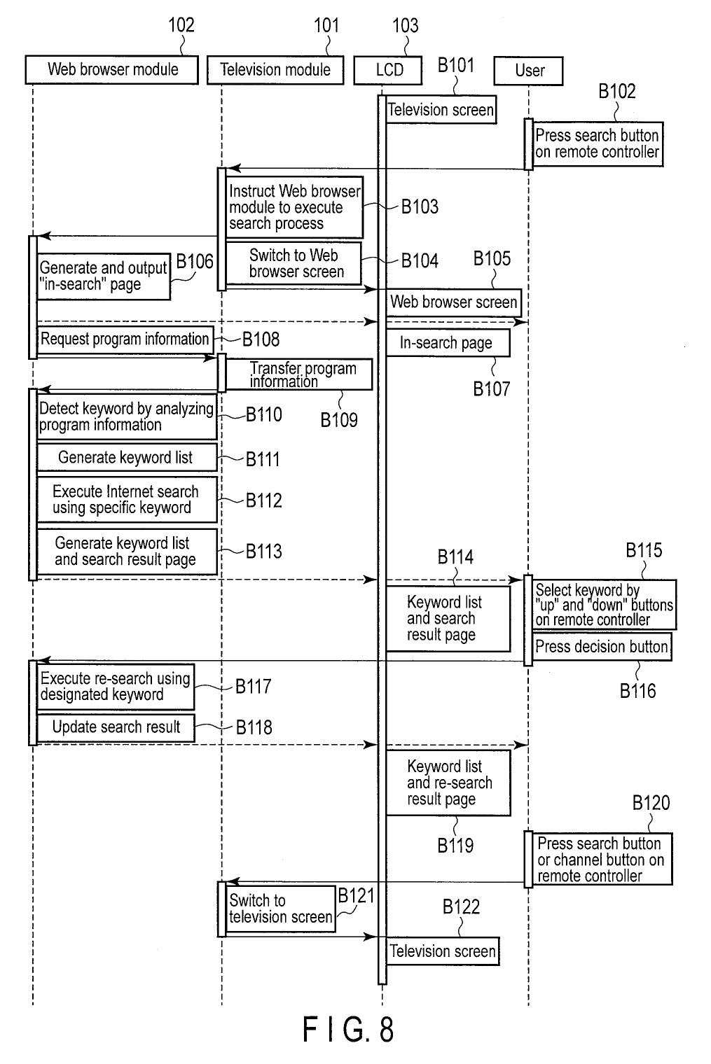

Next, referring to FIG. 8, a description is given of an example of the procedure of a display control process by the digital broadcast receiver 11. In the process shown in FIG. 8, it is assumed that the user requests a Web search relating to a broadcast program while the user is viewing this broadcast program.

To start with, the LCD 103 displays a television screen 5 by using video data output from the video processor 202 (block B101). To be more specific, the airwave processor 201 demodulates a broadcast signal of a first channel which has been selected from receivable broadcast signals of channels by the tuner 111. The airwave processor 201 then extracts video data and audio data, and service information (SI) including information (EPG information) for displaying an electronic program guide, form the demodulated signal. The video processor 202 executes the first process of displaying video on the LCD 103 and outputting audio to the speaker 105 by using the video data and audio data. The LCD 103 displays first video (i.e. a television screen 5) by using video data which has been subjected to the first process. The speaker 105 outputs audio by using audio data which has been subjected to the first process. In addition, the EPG processor 203A extracts the EPG information included in the SI during the first process, and then stores the extracted EPG information in the RAM 113, a storage device, or the like.

The user presses the “search” button 401 on the remote controller 108, while the user is viewing a program (i.e. during the first process of broadcast program data) (block B102). The remote control signal receiver 114 of the television module 101 receives a control signal (search command) for requesting a Web search relating to the program, from the remote controller 108. The remote control signal receiver 114 outputs the received signal to the user operation processor 203C. Then, in response to the control signal from the remote control signal receiver 114, the user operation processor 203C notifies the search instruction module 203B and video processor 202 that the Web search has been requested.

In response to this notification, the search instruction module 203B requests the Web browser module 102 to execute a search process via an internal LAN connection (inter-module communication module 205 and LAN terminal 207) (block B103). In addition, in response to the notification by the user operation processor 203C, the video processor 202 switches the screen that is displayed on the LCD 103 from the television screen 5 to the Web browser screen 6 (block B104). Specifically, the video processor 202 switches the video data, which is output to the LCD 103, from the video data output from the airwave processor 201 to the external video data output from the HDMI receiver 204. The LCD 103 displays the Web browser screen 6 by using the external video data output from the video processor 202 (block B105).

Next, the HTML page generator 301 of the Web browser module 102 generates a Web page (in-search page) which indicates that “a search is being executed”, in response to a request from the search instruction module 203B of the television module 101, and the display controller 305 transmits external video data for displaying the generated Web page to the television module 101 via the HDMI connection (HDMI transmitter 306 and HDMI terminal 307) (block B106).

Since the external video data transmitted from the Web browser module 102 is output to the LCD 103 by the switching to the Web browser screen 6 in block B105, the LCD 103 displays the in-search page (block B107).

Next, the HTML page generator 301 requests the television module 101 to transmit program information relating to the program that is being viewed (i.e. program information of the channel that is being viewed when the Web search has been requested) via the internal LAN connection (inter-module communication module 304 and LAN terminal 308) (block B108).

In response to the request from the HTML page generator 301, the search instruction module 203B reads from the RAM 113 the program information corresponding to the program that is being viewed, and transmits the read program information to the Web browser module 102 via the internal LAN connection (block B109).

The HTML page generator 301 receives the transmitted program information via the internal LAN connection, and the keyword analyzer 302 of the Web browser module 102 detects keywords included in the program information by analyzing the received program information (block B110). Using detected keywords, the keyword analyzer 302 generates a list of keywords in the program information (block B111). Then, the internet search module 303 executes an Internet search (Web search) using a specific keyword of the keywords in the generated list (block B112). The internet search module 303 acquires a Web search result relating the specific keyword, for example, by using the API for executing a search process which is similar to a search on a Web search site.

The HTML page generator 301 generates a Web page (search result page) 65 including the keyword list and the Web search result (block B113). Then, the display controller 305 transmits external video data for displaying the generated search result page 65 to the television module 101 via the HDMI connection. The LCD 103 displays the search result page 65 including the keyword list and the Web search result, by using the transmitted external video data (block B114).

For example, by an operation of pressing the “up” button 402U or “down” button 402D on the remote controller 108, the user sets one keyword in the selected state, which is selected from the keyword list (program title area 61 and performer name area 62) displayed on the search result page (block B115). Specifically, the user moves the focus of the keyword by the operation of pressing the “up” button 402U or “down” button 402D. Then, by an operation of pressing the “decision” button 403 on the remote controller 108, the user requests a Web search relating to the selected keyword (focused keyword) (block B116). Specifically, the remote control signal receiver 114 of the television module 101 receives a control signal indicative of “up”, a control signal indicative of “down” or a control signal indicative of “decision”, which has been output from the remote controller 108. The remote control signal receiver 114 outputs the received control signal to the user operation processor 203C. The user operation processor 203C notifies the search instruction module 203B of the operation information corresponding to the control signal output from the remote control signal receiver 114. The search instruction module 203B transmits the operation information to the Web browser module 102 via the internal LAN connection.

Using this operation information, the HTML page generator 301 detects a keyword in the keyword list, which has been selected by the user, and the internet search module 303 executes once again an Internet search by this keyword, thereby acquiring a search result relating to the selected keyword (block B117). Using the acquired search result, the HTML page generator 301 updates the search result page 65 displayed on the LCD 103 (block B118). The display controller 305 transmits external video data for displaying the updated search result page 65 to the television module 101 via the HDMI. Using the transmitted external video data, the LCD 103 displays the updated search result page 65 (block B119).

Next, the user executes, for example, an operation of pressing the “search” button 401 or any one of the “channel” buttons 404 on the remote controller 108, thereby requesting that the screen displayed on the LCD 103 be switched from the Web browser screen 6 to the television screen 5 (block B120). Specifically, the remote control signal receiver 114 of the television module 101 receives a control signal for requesting the switching to the television screen 5, from the remote controller 108. The remote control signal receiver 114 outputs the received control signal to the user operation processor 203C. Then, the user operation processor 203C notifies the video processor 202 that the switching to the television screen 5 has been requested. In the meantime, when a control signal corresponding to the “channel” button 404 is received from the remote control signal receiver 114, the user operation processor 203C may further request the tuner 111 to select a broadcast signal of this channel.

In response to the notification by the user operation processor 203, the video processor 202 switches the screen on the LCD 103 from the Web browser screen 6 to the television screen 5 (block B121). Specifically, the video processor 202 switches the video data, which is output to the LCD 103, from the external video data output from the HDMI receiver 204 to the video data output from the airwave processor 201. The LCD 103 displays the television screen 5 by using the video data output from the video processor 202 (block B122).

As has been described above, according to the present embodiment, a Web search result relating to a program that is being viewed can quickly be presented in response to a request by the user. When a predetermined operation by the user has been executed while the video of the broadcast program is being displayed on the LCD 103, keywords are extracted from the EPG information which is associated with this broadcast program. Then, using a specific keyword of the extracted keywords, a Web search can also be automatically executed. Thereby, without the user performing an operation of inputting a character string by using a keyboard or the like, a Web search result using the keyword relating to the broadcast program can be displayed on the screen.

Besides, the digital broadcast receiver 11 of this embodiment is provided with the television module 101 which realizes a television function, and the Web browser module 102 which realizes a Web browser function. The television screen 5 and Web browser screen 6 are switched, for example, in accordance with an operation by the user, and are displayed. In this manner, by providing the separate modules for the television function and Web browser function, a Web search result relating to the program that is being viewed can quickly be presented in accordance with the request by the user.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a television module and a Web browser module,
the television module comprising
a tuner configured to receive a broadcast signal of a first channel;
a video processor configured to display first video on a screen by using video data of a first broadcast program, wherein the video data is carried by the broadcast signal;
program information storage configured to store electronic program guide information extracted from the broadcast signal in storage;
a program information extractor configured to extract first program information of the first broadcast program from stored electronic program guide information while the first video is being displayed;
a first communicator configured to transmit the first program information to the Web browser module; and
a video input configured to receive external video data transmitted from the Web browser module,
the video processor being configured to display second video on the screen by using the external video data while the first video is being displayed, and
the Web browser module comprising
a second communicator configured to receive the first program information from the television module;
a keyword extractor configured to extract one or more keywords from the first program information;
a retriever configured to retrieve information relating to a first keyword of the one or more keywords after the first keyword is transmitted to a first server; and
a video output configured to transmit the external video data to the television module, the external video data being suitable for displaying a list of the one or more keywords and the information relating to the first keyword.

2. The electronic apparatus of claim 1, wherein the video processor is configured to display the first video when a first user operation is executed while the second video is being displayed.

3. The electronic apparatus of claim 1, wherein the television module further comprises
a remote control signal receiver configured to receive a control signal transmitted from a remote controller comprising buttons; and
a user operation detector configured to detect the control signal as a first user operation, wherein the control signal is indicative of pressing of a first button of the buttons.

4. The electronic apparatus of claim 1, wherein the keyword extractor is configured to extract the one or more keywords by executing an analysis of a character string in the first program information.

5. The electronic apparatus of claim 1, wherein the one or more keywords comprise a program title and a performer name of the first broadcast program, and
the first keyword is the program title.

6. The electronic apparatus of claim 1, wherein the first keyword is a keyword that is selected by a user from the one or more keywords.

7. The electronic apparatus of claim 1, wherein the video input and the video output are connectable by using a high-definition multimedia interface (HDMI) connection.

8. The electronic apparatus of claim 7, wherein the video input and the video output are connectable via a first terminal and a second terminal that are within a housing of the electronic apparatus.

9. The electronic apparatus of claim 1, wherein the video processor is further configured to output audio to a speaker by using audio data of the first broadcast program, and the audio data is carried by the broadcast signal of the first channel.

10. The electronic apparatus of claim 1, wherein the video output is further configured to transmit external audio data to the television module,
the video input is further configured to receive the external audio data, and
the video processor is configured to output audio to a speaker by using the external audio data while the first video is being displayed.

11. The electronic apparatus of claim 1, wherein, while the first video is being displayed, the video processor is configured to display the second video on the screen by using the external video data and to output audio to a speaker by using audio data of the first broadcast program, and the audio data is carried by the broadcast signal of the first channel.

12. A display control method for displaying information relating to a broadcast program by controlling an electronic apparatus comprising a television module and a Web browser module, the method comprising:
displaying, by the television module, first video on a screen by using video data of a first broadcast program, wherein the video data is carried by a broadcast signal, and the broadcast signal is received by a tuner in the television module;
storing electronic program guide information extracted from the broadcast signal in a storage;
extracting first program information of the first broadcast program from stored electronic program guide information while the first video is being displayed;
transmitting the first program information to the Web browser module;
receiving, by the Web browser module, the first program information;
extracting one or more keywords from the first program information;
retrieving information relating to a first keyword of the one or more keywords after the first keyword is transmitted to a first server;
transmitting external video data to the television module, the external video data being suitable for displaying a list of the one or more keywords and the information relating to the first keyword;
receiving the external video data transmitted from the Web browser module; and
displaying, by the television module, second video on the screen by using the external video data.
